(19) United States
(12) Patent Application Publication
(10) Pub. No.: US 2026/0206773 A1
(43) Pub. Date: Jul. 23, 2026

(54) BAKED PRODUCT

(71) Applicant: Intercontinental Great Brands LLC, East Hanover, NJ (US)

(72) Inventors: Indraneil Mukherjee, East Hanover, NJ (US); Clive Norton, East Hanover, NJ (US); Lawrence Harris, East Hanover, NJ (US)

(21) Appl. No.: 19/142,042

(22) PCT Filed: Dec. 20, 2023
(86) PCT No.: PCT/US2023/085119

§ 371 Date: Jun. 20, 2025

Related U.S. Application Data
(60) Provisional application No. 63/434,424, filed on Dec. 21, 2022.

(51) Int. Cl. A21D 13/80; A21D 2/26; A21D 2/36; A21D 13/02; A21D 13/32

(52) U.S. Cl. CPC A21D 13/80; A21D 2/263; A21D 2/364; A21D 13/02; A21D 13/32

(57) ABSTRACT

The present invention relates to a baked product comprising at least one confectionery component and a baked component, wherein between the confectionery component and the baked component there is: a) at least 10.6 g of a dairy derived ingredient per 30-50 g of the baked product; and b) at least 14.17 g of an ingredient derived from nuts and/or seeds and/or at least 10.6 g of a wholegrain ingredient per 30-50 g of the baked product. The present invention also relates to a baked product comprising at least one baked component comprising an ingredient derived from nuts and/or seeds in an amount of at least 14.17 g per 30-50 g of the baked product and a wholegrain ingredient in an amount of at least 10.6 g per 30-50 g of the baked product.

### TECHNICAL FIELD OF THE INVENTION

The present invention relates to baked products and packaged baked products. The invention also relates to methods of preparing such baked products.

### BACKGROUND TO THE INVENTION

Many baked products on the market are considered energy dense foods; driven largely by sugar and fat-based ingredients necessary for the characteristic structure, taste, color and texture.

There has been significant attention to sugar and higher energy dense foods in recent years and opportunities exist to develop lower sugar and/or energy baked products.

Moreover, there is also the need to develop nutritious baked products able to provide one or more of the food groups recommended for consumption by the Dietary Guidelines in some territories.

One solution to this problem may be to provide these food groups as additional ingredients in existing formulations. However, the serving size of baked products are limited in order to not exceed daily recommended consumption. Typically, the recommended serving size for a baked product is 30 g.

Consequently, there exists a problem in providing one or more food groups in a recommended serving size of a baked product without compromising texture, taste, color and mouthfeel.

Therefore, it is an aim of the present invention to provide a baked product that is able to provide one or more food groups per serving.

It is also an aim of the present invention to provide a baked product which includes a confectionery component and which provides one or more of the following advantages:
Improved antioxidation properties and/or reduced rancidity;
Have relatively low saturated fat and/or sugar content.
Provide a good mouthfeel.

It is also an aim of embodiments of the invention to overcome or mitigate at least one problem of the prior art, whether expressly described herein or not.

### SUMMARY OF THE INVENTION

According to a first aspect of the invention, there is a baked product comprising at least one confectionery component and a baked component, wherein between the confectionery component and the baked component there is:
a) at least 10.6 g of one or more dairy derived ingredients per 30-50 g of the baked product; and
b) at least 14.17 g of an ingredient derived from nuts and/or seeds and/or at least 10.6 g of a wholegrain ingredient per 30-50 g of the baked product.

The dairy derived ingredient may be derived from one or more ingredients selected from the group comprising whole milk, skimmed milk, low fat milk, skimmed milk powder, low fat milk powder, whole milk powder, whey powder, anhydrous milk fat, or combinations thereof.

For example, the dairy derived ingredient may be at least one ingredient selected from the group comprising: one or more milk proteins; and one or more milk sugars derived from the group comprising whole milk, skimmed milk, low fat milk, skimmed milk powder, low fat milk powder, whole milk powder, anhydrous milk fat, and whey powder.

The milk protein may be one or more proteins selected from the group comprising casein (for example selected from αs1-casein, αs2-casein, β-casein and κ-casein) and whey (for example selected from whey protein concentrate, whey protein isolate and whey protein hydrolysate).

The milk sugar may be lactose.

The confectionery component may comprise one or more milk sugars.

The confectionery component may comprise lactose.

Preferably, the confectionery component comprises lactose derived from at least one ingredient selected from the group comprising: whole milk, skimmed milk, low fat milk, skimmed milk powder and whey powder, low fat milk powder and whole milk powder.

The baked component may comprise one or more milk proteins.

The baked component may comprise casein and/or whey.

Preferably, the baked component comprises casein and/or whey derived from at least one dairy ingredient selected from the group comprising: whole milk, skimmed milk, low fat milk, skimmed milk powder and whey powder, low fat milk powder, and whole milk powder.

The ingredient derived from nuts and/or seeds may be at least one ingredient selected from the group comprising a nut butter, a seed butter, a nut paste, a seed paste, a nut oil, a seed oil, a nut fat, a seed fat, a nut meal and a seed meal.

The term “nuts” as used herein includes true nuts, ground nuts, tree nuts, seeds considered nuts in the culinary sense, and legumes. Examples of legumes which may fall within the term “nuts” include peanut or carob.

In some embodiments, the confectionery component and/or the baked component may comprise an ingredient derived from nuts and/or seeds.

In such embodiments, the confectionery component may comprise at least one ingredient selected from the group comprising a nut butter, a seed butter, a nut paste, a seed paste, a nut oil, a seed oil, a nut fat, a seed fat, a nut meal and a seed meal.

In some embodiments, the baked component may comprise at least one ingredient selected from the group comprising a nut butter, a seed butter, a nut paste, a seed paste, a nut oil, a seed oil, a nut fat, a seed fat, a nut meal and a seed meal.

In some embodiments, the confectionery component may comprise at least one ingredient selected from the group comprising a nut butter, a seed butter, a nut paste, a seed paste, a nut oil, a seed oil, a nut fat, a seed fat, a nut meal and a seed meal; and the baked component may comprise at least one ingredient selected from the group comprising a nut butter, a seed butter, a nut paste, a seed paste, a nut oil, a seed oil, a nut fat, a seed fat, a nut meal and a seed meal.

The ingredient derived from nuts and/or seeds may be derived from one or more nuts and/or seeds selected from the group comprising almonds, peanuts, macadamia nuts, hazelnuts, coconut, pecans, palm, walnuts, pistachios, cashews, Brazil nuts, sunflower seeds, poppy seeds, pumpkin seeds, chia seeds, canola seeds coffee beans, cocoa beans, watermelon seeds, soy nuts, chestnuts, pine nut or any combination thereof.

In some embodiments, the confectionery component comprises a nut and/or seed fat.

In some embodiments, the baked component comprises a nut and/or seed meal.

Preferably, the confectionery component comprises a nut and/or seed fat; and the baked component comprises a nut and/or seed meal.

The ingredients derived from nuts and/or seeds may be derived from the same nuts and/or seeds.

Alternatively, the ingredients derived from nuts and/or seeds may be derived from different nuts and/or seeds.

The wholegrain ingredient may include any type and form of whole grain ingredient. For example, the whole grain ingredients may be selected from the group comprising wheat, oat, barley, maize, brown rice, faro, spelt, emmer, rye, quinoa, amaranth, triticale and buckwheat.

The whole grain ingredient may take a variety of forms selected from the group comprising whole grain flour, wheat flour, intact, ground, flaked, cracked, etc. forms of grains and/or portions of grains as constituting whole grains. In accordance with the invention the whole grain ingredient includes germ, bran and endosperm, though other components are also contemplated.

The baked component and/or the confectionery component may comprise the wholegrain ingredient.

Preferably, the baked component comprises the wholegrain ingredient.

Between the confectionery component and the baked component there may be at least 10.6 g, 10.7, 10.8, 10.9, 11.0, 11.1, 11.2, 11.3, 11.4, 11.5, 11.6, 11.7, 11.8, 11.9 or at least 12.0 g of a dairy derived ingredient per 30 g of the baked product; and at least 14.17 g, 14.2, 14.3, 14.4, 15.5, 14.6, 14.7, 14.8, 14.9, 15.0, 15.1, 15.2, 15.3, 15.4, or at least 15.5 g of an ingredient derived from nuts and/or seeds per 30 g of the baked product.

Between the confectionery component and the baked component there may be no more than 12.0 g, 11.9, 11.8, 11.7, 11.6, 11.5, 11.4, 11.3, 11.2, 11.1, 11.0, 10.9, 10.8, 10.7 or no more than 10.6 g of a dairy derived ingredient per 30 g of the baked product; and no more than 15.5 g, 15.4, 15.3, 15.2, 15.1, 15.0, 14.9, 14.8, 14.7, 14.6, 14.5, 14.4, 14.3, 14.2, or no more than 14.1 g of an ingredient derived from nuts and/or seeds per 30 g of the baked product.

Between the confectionery component and the baked component there may be from 10.6-15.5 g, 10.6-15.4, 10.6-15.3, 10.6-15.2, 10.6-15.1, 10.6-15.0, 10.6-14.9, 10.6-14.8, 10.6-14.7, 10.6-14.6, 10.6-14.5, 10.6-14.4, 10.6-14.3, 10.6-14.2, 10.6-14.1 or from 10.6-14.0 g of a dairy derived ingredient per 30 g of the baked product; and from 14.17-15.5 g, 14.17-15.4, 14.27-15.3, 14.17-15.2, 14.17-15.1, 14.17-15.0 g of an ingredient derived from nuts and/or seeds per 30 g of the baked product. 15 Between the confectionery component and the baked component there may be at least 10.6 g, 10.7, 10.8, 10.9, 11.0, 11.1, 11.2, 11.3, 11.4, 11.5, 11.6, 11.7, 11.8, 11.9, 12.0, 12.5, 13.0, 13.5, 14.0, 14.5, 15.0 g of a dairy derived ingredient per 30 g of the baked product; and at least 10.6 g, 10.7, 10.8, 10.9, 11.0, 11.1, 11.2, 11.3, 11.4, 11.5, 11.6, 11.7, 11.8, 11.9 or at least 12.0 g of a wholegrain ingredient per 30 g of the baked product.

Between the confectionery component and the baked component there may be no more than 12.0 g, 11.9, 11.8, 11.7, 11.6, 11.5, 11.4, 11.3, 11.2, 11.1, 11.0, 10.9, 10.8, 10.7 or no more than 10.6 g of a dairy derived ingredient per 30 g of the baked product; and no more than 12.0 g, 11.9, 11.8, 11.7, 11.6, 11.5, 11.4, 11.3, 11.2, 11.1, 11.0, 10.9, 10.8, 10.7 or no more than 10.6 g of a wholegrain ingredient per 30 g of the baked product.

Between the confectionery component and the baked component there may be from 10.6-15.5 g, 10.6-15.4, 10.6-15.3, 10.6-15.2, 10.6-15.1, 10.6-15.0, 10.6-14.9, 10.6-14.8, 10.6-14.7, 10.6-14.6, 10.6-14.5, 10.6-14.4, 10.6-14.3, 10.6-14.2, 10.6-14.1 or from 10.6-14.0 g of a dairy derived ingredient per 30 g of the baked product; and from 10.6-15.5 g, 10.6-15.4, 10.6-15.3, 10.6-15.2, 10.6-15.1, 10.6-15.0, 10.6-14.9, 10.6-14.8, 10.6-14.7, 10.6-14.6, 10.6-14.5, 10.6-14.4, 10.6-14.3, 10.6-14.2, 10.6-14.1 or from 10.6-14.0 g of a wholegrain ingredient per 30 g of the baked product.

Between the confectionery component and the baked component there may be at least 10.6 g, 10.7, 10.8, 10.9, 11.0, 11.1, 11.2, 11.3, 11.4, 11.5, 11.6, 11.7, 11.8, 11.9 or at least 12.0 g of a dairy derived ingredient per 40 g of the baked product; and at least 14.17 g, 14.2, 14.3, 14.4, 15.5, 14.6, 14.7, 14.8, 14.9, 15.0, 15.1, 15.2, 15.3, 15.4, 15.5, 16.0, 16.5, 17.0, 17.5, 18.0, 18.5, or at least 19.0 g of an ingredient derived from nuts and/or seeds per 40 g of the baked product.

Between the confectionery component and the baked component there may be no more than 15.5 g, 15.0, 14.5, 14.0, 13.5, 13.0, 12.5, 12.0, 11.9, 11.8, 11.7, 11.6, 11.5, 11.4, 11.3, 11.2, 11.1, 11.0, 10.9, 10.8, 10.7 or no more than 10.6 g of a dairy derived ingredient per 40 g of the baked product; and no more than 19.0.g, 18.5, 18.0, 17.5, 17.0, 16.5, 16.0, 15.5, 15.4, 15.3, 15.2, 15.1, 15.0, 14.9, 14.8, 14.7, 14.6, 14.5, 14.4, 14.3, 14.2, or no more than 14.1 g of an ingredient derived from nuts and/or seeds per 40 g of the baked product.

Between the confectionery component and the baked component there may be from 10.6-15.5 g, 10.6-15.4, 10.6-15.3, 10.6-15.2, 10.6-15.1, 10.6-15.0, 10.6-14.9, 10.6-14.8, 10.6-14.7, 10.6-14.6, 10.6-14.5, 10.6-14.4, 10.6-14.3, 10.6-14.2, 10.6-14.1 or at least 10.6-14.0 g of a dairy derived ingredient per 40 g of the baked product; and from 14.17-19.0 g, 14.17-18.5, 14.17-18.0, 14.17-17.5, 14.17-17.0, 14.17-16.5, 14.17-16.0, 14.17-15.5, 14.17-15.4, 14.27-15.3, 14.17-15.2, 14.17-15.1, 14.17-15.0 g of an ingredient derived from nuts and/or seeds per 40 g of the baked product.

Between the confectionery component and the baked component there may be at least 10.6 g, 10.7, 10.8, 10.9, 11.0, 11.1, 11.2, 11.3, 11.4, 11.5, 11.6, 11.7, 11.8, 11.9, 12.0, 12.5, 13.0, 13.5, 14.0, 14.5, 15.0 g of a dairy derived ingredient per 40 g of the baked product; and at least 10.6 g, 10.7, 10.8, 10.9, 11.0, 11.1, 11.2, 11.3, 11.4, 11.5, 11.6, 11.7, 11.8, 11.9, 12.0, 12.5, 13.0, 13.5, 14.0, 14.5, 15.0 g of a wholegrain ingredient per 40 g of the baked product.

Between the confectionery component and the baked component there may be no more than 15.0 g, 14.5, 14.0, 13.5, 13.0, 12.5, 12.0, 11.9, 11.8, 11.7, 11.6, 11.5, 11.4, 11.3, 11.2, 11.1, 11.0, 10.9, 10.8, 10.7 or no more than 10.6 g of a dairy derived ingredient per 40 g of the baked product; and no more than 15.0 g, 14.5, 14.0, 13.5, 13.0, 12.5, 12.0, 11.9, 11.8, 11.7, 11.6, 11.5, 11.4, 11.3, 11.2, 11.1, 11.0, 10.9, 10.8, 10.7 or no more than 10.6 g of a wholegrain ingredient per 40 g of the baked product.

Between the confectionery component and the baked component there may be from 10.6-15.5 g, 10.6-15.4, 10.6-15.3, 10.6-15.2, 10.6-15.1, 10.6-15.0, 10.6-14.9, 10.6-14.8, 10.6-14.7, 10.6-14.6, 10.6-14.5, 10.6-14.4, 10.6-14.3, 10.6-14.2, 10.6-14.1 or from 10.6-14.0 g of a dairy derived ingredient per 40 g of the baked product; and from 10.6-15.5 g, 10.6-15.4, 10.6-15.3, 10.6-15.2, 10.6-15.1, 10.6-15.0, 10.6-14.9, 10.6-14.8, 10.6-14.7, 10.6-14.6, 10.6-14.5, 10.6-14.4, 10.6-14.3, 10.6-14.2, 10.6-14.1 or from 10.6-14.0 g of a wholegrain ingredient per 40 g of the baked product.

Between the confectionery component and the baked component there may be at least 10.6 g, 10.7, 10.8, 10.9, 11.0, 11.1, 11.2, 11.3, 11.4, 11.5, 11.6, 11.7, 11.8, 11.9, 12.0 g of a dairy derived ingredient per 40 g of the baked product; at least 14.17 g, 14.2, 14.3, 14.4, 15.5, 14.6, 14.7, 14.8, 14.9, 15.0, 15.1, 15.2, 15.3, 15.4, or at least 15.5 g of an ingredient derived from nuts and/or seeds per 40 g of the baked product; and at least 10.6 g, 10.7, 10.8, 10.9, 11.0, 11.1, 11.2, 11.3, 11.4, 11.5, 11.6, 11.7, 11.8, 11.9, or at least 12.0 g of a wholegrain ingredient per 40 g of the baked product.

Between the confectionery component and the baked component there may be no more than 15.0 g, 14.5, 14.0, 13.5, 13.0, 12.5, 12.0, 11.9, 11.8, 11.7, 11.6, 11.5, 11.4, 11.3, 11.2, 11.1, 11.0, 10.9, 10.8, 10.7 or no more than 10.6 g of a dairy derived ingredient per 40 g of the baked product; no more than 19.0.g, 18.5, 18.0, 17.5, 17.0, 16.5, 16.0, 15.5, 15.4, 15.3, 15.2, 15.1, 15.0, 14.9, 14.8, 14.7, 14.6, 14.5, 14.4, 14.3, 14.2, or no more than 14.1 g of an ingredient derived from nuts and/or seeds per 40 g of the baked product; and no more than 15.0 g, 14.5, 14.0, 13.5, 13.0, 12.5, 12.0, 11.9, 11.8, 11.7, 11.6, 11.5, 11.4, 11.3, 11.2, 11.1, 11.0, 10.9, 10.8, 10.7 or no more than 10.6 g of a wholegrain ingredient per 40 g of the baked product.

Between the confectionery component and the baked component there may be from 10.6-15.5 g, 10.6-15.4, 10.6-15.3, 10.6-15.2, 10.6-15.1, 10.6-15.0, 10.6-14.9, 10.6-14.8, 10.6-14.7, 10.6-14.6, 10.6-14.5, 10.6-14.4, 10.6-14.3, 10.6-14.2, 10.6-14.1 or from 10.6-14.0 g of a dairy derived ingredient per 40 g of the baked product; from 14.17-19.0 g, 14.17-18.5, 14.17-18.0, 14.17-17.5, 14.17-17.0, 14.17-16.5, 14.17-16.0, 14.17-15.5, 14.17-15.4, 14.27-15.3, 14.17-15.2, 14.17-15.1, 14.17-15.0 g of an ingredient derived from nuts and/or seeds per 40 g of the baked product; and from 10.6-15.5 g, 10.6-15.4, 10.6-15.3, 10.6-15.2, 10.6-15.1, 10.6-15.0, 10.6-14.9, 10.6-14.8, 10.6-14.7, 10.6-14.6, 10.6-14.5, 10.6-14.4, 10.6-14.3, 10.6-14.2, 10.6-14.1 or from 10.6-14.0 g of a wholegrain ingredient per 40 g of the baked product.

Between the confectionery component and the baked component there may be at least 10.6 g, 10.7, 10.8, 10.9, 11.0, 11.1, 11.2, 11.3, 11.4, 11.5, 11.6, 11.7, 11.8, 11.9, 12.0, 12.5, 13.0, 13.5, 14.0, 14.5, 15.0, 15.5, 16.0, 16.5, 17.0, 17.5, 18.0, 18.5, 19.0, 19.5, 20.0 g of a dairy derived ingredient per 50 g of the baked product; at least 14.17 g, 14.2, 14.3, 14.4, 15.5, 14.6, 14.7, 14.8, 14.9, 15.0, 15.1, 15.2, 15.3, 15.4, 15.5, 16.0, 16.5, 17.0, 18.5, 19.0, or at least 20.0 g of an ingredient derived from nuts and/or seeds per 50 g of the baked product;

Between the confectionery component and the baked component there may be no more than 20.0 g, 19.5, 19.0, 18.5, 18.0, 17.5, 17.0, 16.5, 16.0, 15.5, 15.0, 14.5, 14.0, 13.5, 13.0, 12.5, 12.0, 11.9, 11.8, 11.7, 11.6, 11.5, 11.4, 11.3, 11.2, 11.1, 11.0, 10.9, 10.8, 10.7 or no more than 10.6 g of a dairy derived ingredient per 50 g of the baked product; and no more than 20.0 g, 19.5, 19.0, 18.5, 18.0, 17.5, 17.0, 16.5, 16.0, 15.5, 15.4, 15.3, 15.2, 15.1, 15.0, 14.9, 14.8, 14.7, 14.6, 14.5, 14.4, 14.3, 14.2, or no more than 14.1 g of an ingredient derived from nuts and/or seeds per 50 g of the baked product.

Between the confectionery component and the baked component there may be from 10.6-20.0 g, 10.6-19.5, 10.6-19.0, 10.6-18.5, 10.6-18.0, 10.6-17.5, 10.6-17.0, 10.6-16.5, 10.6-16.0, 10.6-15.5, 10.6-15.4, 10.6-15.3, 10.6-15.2, 10.6-15.1, 10.6-15.0, 10.6-14.9, 10.6-14.8, 10.6-14.7, 10.6-14.6, 10.6-14.5, 10.6-14.4, 10.6-14.3, 10.6-14.2, 10.6-14.1 or at least 10.6-14.0 g of a dairy derived ingredient per 50 g of the baked product; and from 14.17-19.0 g, 14.17-18.5, 14.17-18.0, 14.17-17.5, 14.17-17.0, 14.17-16.5, 14.17-16.0, 14.17-15.5, 14.17-15.4, 14.27-15.3, 14.17-15.2, 14.17-15.1, 14.17-15.0 g of an ingredient derived from nuts and/or seeds per 50 g of the baked product.

Between the confectionery component and the baked component there may be at least 10.6 g, 10.7, 10.8, 10.9, 11.0, 11.1, 11.2, 11.3, 11.4, 11.5, 11.6, 11.7, 11.8, 11.9, 12.0, 12.5, 13.0, 13.5, 14.0, 14.5, 15.0, 15.5, 16.0, 16.5, 17.0, 17.5, 18.0, 18.5, 19.0, 19.5, 20.0 g of a dairy derived ingredient per 40 g of the baked product; and at least 10.6 g, 10.7, 10.8, 10.9, 11.0, 11.1, 11.2, 11.3, 11.4, 11.5, 11.6, 11.7, 11.8, 11.9, 12.0, 12.5, 13.0, 13.5, 14.0, 14.5, 15.5, 16.0, 16.5, 17.0, 17.5, 18.0, 18.5, 19.0, 19.5, or at least 20.0 g of a wholegrain ingredient per 50 g of the baked product.

Between the confectionery component and the baked component there may be no more than 20.0 g, 19.5, 19.0, 18.5, 18.0, 17.5, 17.0, 16.5, 16.0, 15.5, 15.0, 14.5, 14.0, 13.5, 13.0, 12.5, 12.0, 11.9, 11.8, 11.7, 11.6, 11.5, 11.4, 11.3, 11.2, 11.1, 11.0, 10.9, 10.8, 10.7 or no more than 10.6 g of a dairy derived ingredient per 50 g of the baked product; and no more than 20.0 g, 19.5, 19.0, 18.5, 18.0, 17.5, 17.0, 16.5, 16.0, 15.5, 15.0, 14.5, 14.0, 13.5, 13.0, 12.5, 12.0, 11.9, 11.8, 11.7, 11.6, 11.5, 11.4, 11.3, 11.2, 11.1, 11.0, 10.9, 10.8, 10.7 or no more than 10.6 g of a wholegrain ingredient per 50 g of the baked product.

Between the confectionery component and the baked component there may be from 10.6-20.0 g, 10.6-19.5, 10.6-19.0, 10.6-18.5, 10.6-18.0, 10.6-17.5, 10.6-17.0, 10.6-16.5, 10.6-16.0, 10.6-15.5, 10.6-15.4, 10.6-15.3, 10.6-15.2, 10.6-15.1, 10.6-15.0, 10.6-14.9, 10.6-14.8, 10.6-14.7, 10.6-14.6, 10.6-14.5, 10.6-14.4, 10.6-14.3, 10.6-14.2, 10.6-14.1 or at least 10.6-14.0 g of a dairy derived ingredient per 50 g of the baked product; and from 10.6-20.0 g, 10.6-19.5, 10.6-19.0, 10.6-18.5, 10.6-18.0, 10.6-17.5, 10.6-17.0, 10.6-16.5, 10.6-16.0, 10.6-15.5, 10.6-15.4, 10.6-15.3, 10.6-15.2, 10.6-15.1, 10.6-15.0, 10.6-14.9, 10.6-14.8, 10.6-14.7, 10.6-14.6, 10.6-14.5, 10.6-14.4, 10.6-14.3, 10.6-14.2, 10.6-14.1 or from 10.6-14.0 g of a wholegrain ingredient per 50 g of the baked product.

Between the confectionery component and the baked component there may be at least 10.6 g, 10.7, 10.8, 10.9, 11.0, 11.1, 11.2, 11.3, 11.4, 11.5, 11.6, 11.7, 11.8, 11.9, 12.0, 12.5, 13.0, 13.5, 14.0, 14.5, 15.0 g of a dairy derived ingredient per 50 g of the baked product; at least 14.17 g, 14.2, 14.3, 14.4, 15.5, 14.6, 14.7, 14.8, 14.9, 15.0, 15.1, 15.2, 15.3, 15.4, 15.5, 16.0, 16.5, 17.0, 18.5, 19.0, or at least 20.0 g of an ingredient derived from nuts and/or seeds per 50 g of the baked product; and at least 10.6 g, 10.7, 10.8, 10.9, 11.0, 11.1, 11.2, 11.3, 11.4, 11.5, 11.6, 11.7, 11.8, 11.9, 12.0, 12.5, 13.0, 13.5, 14.0, 14.5, or at least 15.0 g of a wholegrain ingredient per 50 g of the baked product.

Between the confectionery component and the baked component there may be no more than 20.0 g, 19.5, 19.0, 18.5, 18.0, 17.5, 17.0, 16.5, 16.0, 15.5, 15.0, 14.5, 14.0, 13.5, 13.0, 12.5, 12.0, 11.9, 11.8, 11.7, 11.6, 11.5, 11.4, 11.3, 11.2, 11.1, 11.0, 10.9, 10.8, 10.7 or no more than 10.6 g of a dairy derived ingredient per 50 g of the baked product; 20.0 g, 19.5, 19.0, 18.5, 18.0, 17.5, 17.0, 16.5, 16.0, 15.5, 15.4, 15.3, 15.2, 15.1, 15.0, 14.9, 14.8, 14.7, 14.6, 14.5, 14.4, 14.3, 14.2, or no more than 14.1 g of an ingredient derived from nuts and/or seeds per 50 g of the baked product; and no more than 20.0 g, 19.5, 19.0, 18.5, 18.0, 17.5, 17.0, 16.5, 16.0, 15.5, 15.0, 14.5, 14.0, 13.5, 13.0, 12.5, 12.0, 11.9, 11.8, 11.7, 11.6, 11.5, 11.4, 11.3, 11.2, 11.1, 11.0, 10.9, 10.8, 10.7 or no more than 10.6 g of a wholegrain ingredient per 50 g of the baked product.

Between the confectionery component and the baked component there may be from 10.6-20.0 g, 10.6-19.5, 10.6-19.0, 10.6-18.5, 10.6-18.0, 10.6-17.5, 10.6-17.0, 10.6-16.5, 10.6-16.0, 10.6-15.5, 10.6-15.4, 10.6-15.3, 10.6-15.2, 10.6-15.1, 10.6-15.0, 10.6-14.9, 10.6-14.8, 10.6-14.7, 10.6-14.6, 10.6-14.5, 10.6-14.4, 10.6-14.3, 10.6-14.2, 10.6-14.1 or at least 10.6-14.0 g of a dairy derived ingredient per 50 g of the baked product; from 14.17-19.0 g, 14.17-18.5, 14.17-18.0, 14.17-17.5, 14.17-17.0, 14.17-16.5, 14.17-16.0, 14.17-15.5, 14.17-15.4, 14.27-15.3, 14.17-15.2, 14.17-15.1, 14.17-15.0 g of an ingredient derived from nuts and/or seeds per 50 g of the baked product; and from 10.6-20.0 g, 10.6-19.5, 10.6-19.0, 10.6-18.5, 10.6-18.0, 10.6-17.5, 10.6-17.0, 10.6-16.5, 10.6-16.0, 10.6-15.5, 10.6-15.4, 10.6-15.3, 10.6-15.2, 10.6-15.1, 10.6-15.0, 10.6-14.9, 10.6-14.8, 10.6-14.7, 10.6-14.6, 10.6-14.5, 10.6-14.4, 10.6-14.3, 10.6-14.2, 10.6-14.1 or from 10.6-14.0 g of a wholegrain ingredient per 50 g of the baked product.

The baked product may comprise one or more further ingredients.

The one or more further ingredients may be located in the confectionery component and/or the baked component.

The further ingredient may be one or more ingredients selected from the group comprising a sugar, fat, oil, emulsifier, thickener, preservative, water, colors, flavors, sweetener, salts and sugar replacer, among others.

The term “sugar” refers to a monosaccharide or disaccharide with an energy content of >3 kcal/g. Examples of suitable sugars include glucose, fructose, galactose, sucrose, lactose, maltose, and sugar hydrates (such as dextrose monohydrate, for example), among others.

The term “sugar replacer” is taken to include bulking agents, high potency sweeteners, and protein-based sugar replacers. Bulking agents include but are not limited to monosaccharides or disaccharides having an energy content of ≤3 kcal/g; oligosaccharides; polysaccharides; sugar alcohols (including hydrogenation products of any monosaccharides, disaccharides, and of oligosaccharides/polysaccharides containing 3 or more monosaccharide units); dietary fiber (both insoluble and soluble); grains; cereals; resistant starches and flours containing resistant starches; novel bulking agents (such as powdered insects, algae biomass, upcycled plant material, seaweed, sand, calcium carbonate, and other minerals); and any combinations thereof, among others.

Suitable oligosaccharides may be selected from the group comprising: galactooligosaccharides (GOS), fructooligosaccharides (FOS), isomaltoligosaccharides (IMO), xylooligosaccharides (XOS), raffinoses, cellotriose, xylotriose, kojitriose, human milk oligosaccharides, dextrins, xylodextrins, cellodextrins, partially hydrolysed hemicellulose (including hemicellodextrin), digestion resistant cyclodextrins, and combinations thereof, among others.

Suitable polysaccharides may be selected from the group comprising: inulins, arabinoxylans, pectins, polyglycitols, resistant starches, starch, celluloses, hemicelluloses, xylan, and combinations thereof, among others.

Suitable dietary fibers may be selected from the group comprising: polydextrose, maltodextrins, vegetable-derived fibers, plant-derived fibers, cellulose-derived fibers, hemicellulose based fibers, resistant dextrins, soluble corn/wheat fiber, inulin, arabinoxylan, polydextrose, oat fiber, wheat fiber, citrus fiber, pea fiber, micro-crystalline cellulose, cocoa pod husk fiber, maple fiber, pecan shell fiber, brewers spent grain powder, psyllium husk fiber, beta glucan, and combinations thereof, among others.

Suitable starches and/or flours containing resistant starches may be selected from the group comprising: natural high amylose corn/wheat/barley/rice/potato starch (RS2); high amylose corn/wheat/rice flour (RS2); modified starches from various sources (RS4); brans such as corn, oat, rice, wheat and barley bran; and combinations thereof, among others.

The sweetener may be an artificial sweetener and/or natural sweetener.

Artificial sweeteners may be selected from the group comprising: acesulfame K, advantame, alitame, aspartame, aspartame-acesulfame salt, cyclomates, glucin, neohespiridin dihydrochalcone, neotame, saccharin, sucralose, rebaudioside A, rebaudioside D, rebaudioside M and combinations thereof, among others.

Natural sweeteners may be selected from the group comprising: glycyrrhizin, monatin, osladine, stevia, steviol glycosides, monk fruit, mogrosides, and combinations thereof, among others.

The product may comprise at least one emulsifier independently selected from the group comprising: lecithin derived from soya bean, safflower, corn etc., fractionated lecithins enriched with either phosphatidyl choline, phosphatidyl ethanolamine, phosphatidyl inositol; emulsifiers derived from oats, mono- and diglycerides and their tartaric esters, monosodium phosphate derivatives of mono- and diglycerides of edible fats and oils, sorbitan monostearate, polyoxyethylene sorbitan monostearate, hydroxylated lecithin, synthetic phospholipids such as ammonium phosphatides, poly glycerol polyricinoleate (PGPR), lactylated fatty acid esters of glycerol and propylene glycol, poly glycerol esters of fatty acids, citric acid esters of fatty acids, propylene glycol mono- and diesters of fats and fatty acids, and combinations thereof, among others. In certain embodiments, the product may comprise at least one emulsifier selected from: soya lecithin, and synthetic phospholipids such as ammonium phosphatides or polyglycerol polyricinoleate (PGPR).

The addition of at least one emulsifier to the product allows for easier modification of and better control over the rheology of the chocolate product. The emulsifier may act as a rheology modifier.

The flavors may be those traditionally associated with chocolate, such as vanilla, fruit flavorings, mint flavorings, fruit concentrates, spices, hazelnut paste, orange flavor, and the like.

The one or more further ingredients may be present in a total amount of at least 1.0 g, 1.5, 2.0, 2.5, 3.0, 3.5, 4.0, 4.5, 5.0 g per 30-50 g of the baked product.

The one or more further ingredients may be present in a total amount of at least 1.0 g, 1.5, 2.0, 2.5, 3.0, 3.5, 4.0, 4.5, 5.0 g per 30 g of the baked product.

The one or more further ingredients may be present in an amount of no more than 5.0 g, 4.5, 4.0, 3.5, 3.0, 2.5, 2.0, 1.5 g per 30 g of the baked product.

The one or more further ingredients may be present in an amount of from 0.1-5 g, 0.2-5, 0.3-5, 0.4-5, 0.5-5, 0.6-5, 0.7-5, 0.8-5, 0.9-5, 1.0-5, 1.5-5, 2.0-5.0, 2.5-5.0, 3.0-5.0, or from 3.5-5.0 g per 30 g of the baked product.

The one or more further ingredients may be present in a total amount of at least 0.5 g, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 14.0, 14.5, 15.0 g per 40 g of the baked product.

The one or more further ingredients may be present in an amount of no more than 15.0 g, 14.5, 14.0, 13.5, 13.0, 12.5, 12.0, 11.5, 11.0, 10.5, 10.0, 9.5, 9.0, 8.5, 8.0, 7.5, 7.0, 6.5, 6.0, 5.5, 5.0, 4.5, 4.0, 3.5, 3.0, 2.5, 2.0, 1.5 g per 40 g of the baked product.

The one or more further ingredients may be present in an amount of from 0.5-15.0 g, 1.0-15.0, 1.0-14.0, 1.0-13.0, 1.0-12.0, 2.0-11.0, 2.5-10.0, 3.0-9.5, 3.0-8 g per 40 g of the baked product.

The one or more further ingredients may be present in a total amount of at least 0.5 g, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 14.0, 14.5, 15.0, 15.5, 16.0, 16.5, 17.0, 17.5, 18.0, 18.5, 19.0, 19.5, 20.0, 20.5, 21.0, 22.0, 22.5, 23.0, 23.5, 24.0, 24.5, 25.0 g per 50 g of the baked product.

The one or more further ingredients may be present in an amount of no more than 25.0 g, 22.5, 20, 19.0, 18.0, 17.0, 16.0, 15.5, 15.0, 14.5, 14.0, 13.5, 13.0, 12.0, 11.0, 10.0 g per 50 g of the baked product.

The one or more further ingredients may be present in an amount of from 0.1-25.0 g, 0.5-25.0, 1.0-22.5, 1.0-20.0, 2.0-19.0, 3.0-18.0, 4.0-17.0, 5.0-15.0 g per 50 g of the baked product.

The baked product may be temperature-resistant or heat resistant.

In such an embodiment, the baked product may comprise one or more hydrated salts, hydrated sugars and hydrated sugar alcohols.

The confectionery component and/or baked component may comprise one or more hydrated salts, hydrated sugars and hydrated sugar alcohols.

Hydrated salts may be selected from the group comprising hydrates of alkali metal salts and hydrates of alkaline earth metal salts, such as sodium carbonate decahydrate and magnesium carbonate pentahydrate.

Hydrated sugars may be selected from the group comprising hydrated monosaccharides, hydrated disaccharides and hydrated polysaccharides.

Monosaccharides include, for example, dextrose (glucose), fructose (levulose), galactose, xylose and ribose, disaccharides include, for example, saccharose (sucrose) and lactose, and polysaccharides include, for example, starch, glycogen and cellulose. An exemplary and referred hydrated monosaccharide is dextrose monohydrate, and an exemplary and preferred hydrated disaccharide is lactose monohydrate.

The water content of the baked product may be greater than 1.1 wt. % by weight of the baked product. In some embodiments, the total water content may be greater than 1.15 wt. %, 1.2 wt. %, 1.25 wt. %, 1.3 wt. %, 1.35 wt. % or greater than 1.4 wt. % by weight of the baked product. In some embodiments, the water content may be less than 2.5 wt. %, 2.4 wt. %, 2.3 wt. %, 2.2 wt. %, 2.1 wt. % or less than 2.0 wt. % by weight of the baked product. When the water content is as defined above, the composition results in a baked product with improved heat-resistance and also good taste and mouthfeel.

The baked product may comprise a polyol gel product.

The polyol gel may be formed by gelation of a polyol or a polyol/water mixture with a gelling agent. The gelling agents may be selected from the group comprising gelatin, agarose, pectin, xanthan gum, agar, kappa-carrageenan, sodium alginate and iota-carrageenan.

The polyol which is used for gelation is preferably a liquid and may be a straight or branched chain hydrocarbon based compound containing at least two hydroxyl groups on the carbon skeleton. For example, the polyol may be a dihydric alcohol, a trihydric alcohol such as glycerol, mannitol, sorbitol, propylene glycol or corn syrup or any combination thereof.

The addition of a polyol gel to the baked product may improve the heat resistance of the product.

In some embodiments, the baked product may have reduced rancidity and/or be more resistant to oxidation.

In such an embodiment, the baked product may comprise one or more ingredients selected from the group comprising an antioxidant and a preservative.

The baked component and/or confectionery component may comprise antioxidant and/or a preservative.

Suitable antioxidants and/or preservatives may be selected from the group consisting of benzoic acid alkali metal salts (e.g., sodium benzoate), sorbic acid alkali metal salts (e.g., potassium sorbate), ascorbic acid (Vitamin C), citric acid, calcium propionate, sodium erythorbate, sodium nitrite, calcium sorbate, butylated hydroxyanisole (BHA), butylated hydroxytoluene (BHT), ethylenediaminetetraacetic acid (EDTA), tocopherols (Vitamin E), straight chain polyphosphates, or a combination thereof.

In some embodiments, the baked product may comprise a vitamin E compound.

The vitamin E compound may be selected from the group comprising a tocopherol, a tocotrienol, or a combination thereof.

In some embodiments, the vitamin E compound is a tocopherol. Tocopherols are naturally found in vegetable oils, nuts, seeds, and whole grains. Naturally produced forms of the tocopherol as well as synthetic forms can be used. The tocopherols occur in alpha, beta, gamma and delta forms.

In some embodiments, the tocopherol is selected from the group consisting of alpha-tocopherol, beta-tocopherol, gamma-tocopherol, delta-tocopherol, and combinations comprising at least one of the foregoing tocopherols.

In other embodiments, vitamin E compounds such as tocotrienols can also be used to modify, mask or reduce the unpleasant taste impression of a bitter-tasting substance when administered in the presence of at least one fat. Tocotrienols are naturally found in very low levels in select vegetable oils, palm fruit oil, wheat germ, barley, saw palmetto, and certain types of nuts and grains. Naturally produced forms of the tocotrienol as well as synthetic forms can be used.

Tocotrienols, like tocopherols, are members of the vitamin E family and are structurally similar to tocopherol. The tocotrienols, like the tocopherols, occur in alpha, beta, gamma and delta forms. The tocotrienols also have the same methyl structure at the ring, but differ from tocopherols by the presence of three double bonds in the hydrophobic side chain.

The baked product may be resistant to fat bloom and/or sugar bloom.

In such an embodiment, the baked product may comprise a sorbitan monoester.

The term “sorbitan monoester”, as used herein, refers to a sorbitan monoester selected from the group consisting of sorbitan monomyristate, sorbitan monopalmitate, sorbitan monostearate, sorbitan monoarachidate, and combinations thereof.

The sorbitan monoesters described herein are known to have some fat and/or sugar bloom retarding function when included in baked products.

Examples of other additives which may retard fat and/or sugar bloom in baked products may be selected from the group consisting of hydrogenated butter fat, butylated hydroxy anisole (BHA), glycerol, anhydrous glucose, amino acids such as alpha amino N-butyric acid, glycine, cysteine and glutamic acids, bile acids, cetyl alcohol, cholesterol, choline-HCL, citric acid monoglyceride, lactose, low HLB sucrose polyesters, maltrins, methionine, polymerized cocoa butter, phytic acid, polyglycerol fatty esters, propylene glycol fatty acid esters, and combinations thereof.

The baked product may comprise less than 25, 24.9, 24.8, 24.7, 24.6, 24.5, 24.4, 24.3, 24.2, 24.1, 24, 23.9, 23.8, 23.7, 23.6, 23.5, 23.4, 23.3, 23.2, 23.1, 23, 22.9, 22.8, 22.7, 22.6, 22.5, 22.4, 22.3, 22.2, 22.1, 22, 21.9, 21.8, 21.7, 21.6, 21.5, 21.4, 21.3, 21.2, 21.1, 21, 20.9, 20.8, 20.7, 20.6, 20.5, 20.4, 20.3, 20.2, 20.1, 20, 19.9, 19.8, 19.7, 19.6, 19.5, 19.4, 19.3, 19.2, 19.1, 19, 18.9, 18.8, 18.7, 18.6, 18.5, 18.4, 18.3, 18.2, 18.1, 18, 17.9, 17.8, 17.7, 17.6, 17.5, 17.4, 17.3, 17.2, 17.1, 17, 16.9, 16.8, 16.7, 16.6, 16.5, 16.4, 16.3, 16.2, 16.1, 16, 15.9, 15.8, 15.7, 15.6, 15.5, 15.4, 15.3, 15.2, 15.1, 15, 14.9, 14.8, 14.7, 14.6, 14.5, 14.4, 14.3, 14.2, 14.1, 14, 13.9, 13.8, 13.7, 13.6, 13.5, 13.4, 13.3, 13.2, 13.1, 13, 12.9, 12.8, 12.7, 12.6, 12.5, 12.4, 12.3, 12.2, 12.1, 12, 11.9, 11.8, 11.7, 11.6, 11.5, 11.4, 11.3, 11.2, 11.1, 11, 10.9, 10.8, 10.7, 10.6, 10.5, 10.4, 10.3, 10.2, 10.1, 10, 9.9, 9.8, 9.7, 9.6, 9.5, 9.4, 9.3, 9.2, 9.1, 9, 8.9, 8.8, 8.7, 8.6, 8.5, 8.4, 8.3, 8.2, 8.1, 8, 7.9, 7.8, 7.7, 7.6, 7.5, 7.4, 7.3, 7.2, 7.1, 7, 6.9, 6.8, 6.7, 6.6, 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or less than or equal to 0.1 wt % sugar, or 0 wt % sugar by weight of the baked product.

The baked product may comprise less than 25, 24.9, 24.8, 24.7, 24.6, 24.5, 24.4, 24.3, 24.2, 24.1, 24, 23.9, 23.8, 23.7, 23.6, 23.5, 23.4, 23.3, 23.2, 23.1, 23, 22.9, 22.8, 22.7, 22.6, 22.5, 22.4, 22.3, 22.2, 22.1, 22, 21.9, 21.8, 21.7, 21.6, 21.5, 21.4, 21.3, 21.2, 21.1, 21, 20.9, 20.8, 20.7, 20.6, 20.5, 20.4, 20.3, 20.2, 20.1, 20, 19.9, 19.8, 19.7, 19.6, 19.5, 19.4, 19.3, 19.2, 19.1, 19, 18.9, 18.8, 18.7, 18.6, 18.5, 18.4, 18.3, 18.2, 18.1, 18, 17.9, 17.8, 17.7, 17.6, 17.5, 17.4, 17.3, 17.2, 17.1, 17, 16.9, 16.8, 16.7, 16.6, 16.5, 16.4, 16.3, 16.2, 16.1, 16, 15.9, 15.8, 15.7, 15.6, 15.5, 15.4, 15.3, 15.2, 15.1, 15, 14.9, 14.8, 14.7, 14.6, 14.5, 14.4, 14.3, 14.2, 14.1, 14, 13.9, 13.8, 13.7, 13.6, 13.5, 13.4, 13.3, 13.2, 13.1, 13, 12.9, 12.8, 12.7, 12.6, 12.5, 12.4, 12.3, 12.2, 12.1, 12, 11.9, 11.8, 11.7, 11.6, 11.5, 11.4, 11.3, 11.2, 11.1, 11, 10.9, 10.8, 10.7, 10.6, 10.5, 10.4, 10.3, 10.2, 10.1, 10, 9.9, 9.8, 9.7, 9.6, 9.5, 9.4, 9.3, 9.2, 9.1, 9, 8.9, 8.8, 8.7, 8.6, 8.5, 8.4, 8.3, 8.2, 8.1, 8, 7.9, 7.8, 7.7, 7.6, 7.5, 7.4, 7.3, 7.2, 7.1, 7, 6.9, 6.8, 6.7, 6.6, 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or less than or equal to 0.1 wt % added sugar, or 0 wt % added sugar by weight of the baked product.

The term “added sugar” is used herein to refer to an additional amount of sugar that may be naturally present in one of the ingredients, and is added to the baked product during or after processing.

The baked product may comprise less than 25, 24.9, 24.8, 24.7, 24.6, 24.5, 24.4, 24.3, 24.2, 24.1, 24, 23.9, 23.8, 23.7, 23.6, 23.5, 23.4, 23.3, 23.2, 23.1, 23, 22.9, 22.8, 22.7, 22.6, 22.5, 22.4, 22.3, 22.2, 22.1, 22, 21.9, 21.8, 21.7, 21.6, 21.5, 21.4, 21.3, 21.2, 21.1, 21, 20.9, 20.8, 20.7, 20.6, 20.5, 20.4, 20.3, 20.2, 20.1, 20, 19.9, 19.8, 19.7, 19.6, 19.5, 19.4, 19.3, 19.2, 19.1, 19, 18.9, 18.8, 18.7, 18.6, 18.5, 18.4, 18.3, 18.2, 18.1, 18, 17.9, 17.8, 17.7, 17.6, 17.5, 17.4, 17.3, 17.2, 17.1, 17, 16.9, 16.8, 16.7, 16.6, 16.5, 16.4, 16.3, 16.2, 16.1, 16, 15.9, 15.8, 15.7, 15.6, 15.5, 15.4, 15.3, 15.2, 15.1, 15, 14.9, 14.8, 14.7, 14.6, 14.5, 14.4, 14.3, 14.2, 14.1, 14, 13.9, 13.8, 13.7, 13.6, 13.5, 13.4, 13.3, 13.2, 13.1, 13, 12.9, 12.8, 12.7, 12.6, 12.5, 12.4, 12.3, 12.2, 12.1, 12, 11.9, 11.8, 11.7, 11.6, 11.5, 11.4, 11.3, 11.2, 11.1, 11, 10.9, 10.8, 10.7, 10.6, 10.5, 10.4, 10.3, 10.2, 10.1, 10, 9.9, 9.8, 9.7, 9.6, 9.5, 9.4, 9.3, 9.2, 9.1, 9, 8.9, 8.8, 8.7, 8.6, 8.5, 8.4, 8.3, 8.2, 8.1, 8, 7.9, 7.8, 7.7, 7.6, 7.5, 7.4, 7.3, 7.2, 7.1, 7, 6.9, 6.8, 6.7, 6.6, 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or less than or equal to 0.1 wt % saturated fat, or 0 wt % saturated fat by weight of the baked product.

The confectionery component may be one or more materials selected from the group comprising a cream, crème, chocolate, hard candy, jelly candy, chewy candy, toffee, fudge, marshmallow, mousse, gel, fondant, jam, fudge, or paste, among others.

The baked component may be one or more of the group comprising a biscuit, cookie, cake, doughnut, cracker, wafer, pretzel, cereal, pastry, tart, biscotti, short breads, muffins, among others.

The baked product may be a filled baked product.

The filled baked product may comprise a confectionery component as a filling.

In such an embodiment, the confectionery component may be partially or fully surrounded by the baked component. The outer surface area of the confectionery component may be at least 50% surrounded by the baked component, or at least 60, 70, 80, or at least 90%, or substantially 100% of the outer surface area of the confectionery component may be surrounded by the baked component.

In one embodiment, the filled baked product may comprise a component selected from the group comprising a cream, crème, chocolate, hard candy, jelly candy, chewy candy, toffee, fudge, marshmallow, mousse, gel, fondant, jam, and/or fudge confectionery component filling surrounded by one or more components selected from the group comprising a biscuit, cookie, cake, doughnut, cracker, wafer, pretzel, cereal, pastry, tart, biscotti, short bread, and/or muffin baked component.

The baked product may comprise a coated or enrobed baked component. The baked product may comprise a layer of a confectionery component coating material on a surface of the baked component, preferably an outer surface. The baked component may comprise a layer of a confectionery component coating material over at least 50% of the outer surface area of the baked component, or over at least 60, 70, 80, 90%, or over substantially 100% of the outer surface area of the baked component. The coating material may be a chocolate confectionery component.

In such an embodiment, the baked product may comprise one or more of the group selected from a biscuit, cookie, cake, doughnut, cracker, wafer, pretzel, cereal, pastry, tart, biscotti, short bread, and/or muffin baked component coated or enrobed with a chocolate confectionery component.

The term ‘chocolate’ includes any material that meets a legal definition of chocolate in any jurisdiction. However, the term ‘chocolate’ is not limited to material which meets any legal definition of chocolate and also includes chocolate substitutes and analogues. For instance, ‘chocolate’ herein includes materials in which all or part of the cocoa butter (CB) of legally or regulatory-defined chocolate is replaced by cocoa butter equivalents (CBE), cocoa butter substitutes (CBS), cocoa butter replacers (CBR) and/or other lipids. For example, the term “chocolate” also includes chocolates in which part, or all the cocoa butter has been replaced by vegetable fat.

The term ‘cocoa’, as used in any context throughout this specification, is also taken to include the tautologous terminology ‘cacao’.

The chocolate confectionery component may be a non-milk or low milk containing (commonly referred to as plain and/or dark), milk, compound, or white chocolate.

The baked product may comprise a panned coating of a confectionery component on a baked component.

In one embodiment, the baked product may comprise one or more layers of a confectionery component and one or more layers of a baked product. The layers may have an even or uneven thickness. The layers may have a thickness of at least 1, 2, 3, 4, or at least 5 mm. The layer may have a thickness of no greater than 10, 9, 8, 7, 6, or no greater than 5 mm.

In such an embodiment, the baked product may comprise alternating layers of a confectionery component and a baked component. For example, the baked product may comprise a layer of one or more materials selected from the group comprising a cream, chocolate, jelly, toffee, fudge, and/or jam confectionery component sandwiched between two layers of one or more materials selected from the group comprising a biscuit, cookie, cracker, wafer and/or short bread baked component.

In one embodiment, the baked product may comprise a baked component and more than one confectionery component. The baked product may comprise a baked component and a plurality of confectionery components.

In such an embodiment, the confectionery component may be distributed throughout the baked component. For example, the baked product may comprise a cookie or biscuit baked component with a plurality of chocolate chip confectionery components distributed throughout the baked component.

According to a second aspect of the invention there is provided a baked product comprising at least one baked component comprising an ingredient derived from nuts and/or seeds in an amount of at least 14.17 g per 30-50 g of the baked product and a wholegrain ingredient in an amount of at least 10.6 g per 30-50 g of the baked product.

The ingredient derived from nuts and/or seeds may be at least one ingredient selected from the group comprising a nut butter, a seed butter, a nut paste, a seed paste, a nut oil, a seed oil, a nut fat, a seed fat, a nut meal and a seed meal.

The term “nuts” as used herein includes true nuts, ground nuts, tree nuts, seeds considered nuts in the culinary sense, and legumes. Examples of legumes which may fall within the term “nuts” include peanut or carob.

The ingredient derived from nuts and/or seeds may be derived from nuts and/or seeds selected from the group comprising almonds, peanuts, macadamia nuts, hazelnuts, coconut, pecans, palm, walnuts, pistachios, cashews, Brazil nuts, sunflower seeds, poppy seeds, pumpkin seeds, chia seeds, canola seeds coffee beans, cocoa beans, watermelon seeds, soy nuts, chestnuts, pine nut or any combination thereof.

The wholegrain ingredient may include any type and form of whole grain ingredient. For example, the whole grain ingredients may be selected from the group comprising wheat, oat, barley, maize, brown rice, faro, spelt, emmer, rye, quinoa, amaranth, triticale and buckwheat.

The whole grain ingredient may take a variety of forms selected from the group comprising whole grain flour, wheat flour, intact, ground, flaked, cracked, etc. forms of grains and/or portions of grains as constituting whole grains. In accordance with the invention the whole grain ingredient includes germ, bran and endosperm, though other components are also contemplated.

Between the confectionery component and the baked component there may be at least at least 14.17 g, 14.2, 14.3, 14.4, 15.5, 14.6, 14.7, 14.8, 14.9, 15.0, 15.1, 15.2, 15.3, 15.4, or at least 15.5 g of an ingredient derived from nuts and/or seeds per 30 g of the baked product; and at least 10.6 g, 10.7, 10.8, 10.9, 11.0, 11.1, 11.2, 11.3, 11.4, 11.5, 11.6, 11.7, 11.8, 11.9 or at least 12.0 g of a wholegrain ingredient per 30 g of the baked product.

Between the confectionery component and the baked component there may be no more than no more than 15.5 g, 15.4, 15.3, 15.2, 15.1, 15.0, 14.9, 14.8, 14.7, 14.6, 14.5, 14.4, 14.3, 14.2, or no more than 14.1 g of an ingredient derived from nuts and/or seeds per 30 g of the baked product; and no more than 12.0 g, 11.9, 11.8, 11.7, 11.6, 11.5, 11.4, 11.3, 11.2, 11.1, 11.0, 10.9, 10.8, 10.7 or no more than 10.6 g of a wholegrain ingredient per 30 g of the baked product.

Between the confectionery component and the baked component there may be from 14.17-15.5 g, 14.17-15.4, 14.27-15.3, 14.17-15.2, 14.17-15.1, 14.17-15.0 g of an ingredient derived from nuts and/or seeds per 30 g of the baked product; and from 10.6-15.5 g, 10.6-15.4, 10.6-15.3, 10.6-15.2, 10.6-15.1, 10.6-15.0, 10.6-14.9, 10.6-14.8, 10.6-14.7, 10.6-14.6, 10.6-14.5, 10.6-14.4, 10.6-14.3, 10.6-14.2, 10.6-14.1 or from 10.6-14.0 g of a wholegrain ingredient per 30 g of the baked product.

Between the confectionery component and the baked component there may be at least 14.17 g, 14.2, 14.3, 14.4, 15.5, 14.6, 14.7, 14.8, 14.9, 15.0, 15.1, 15.2, 15.3, 15.4, or at least 15.5 g of an ingredient derived from nuts and/or seeds per 40 g of the baked product; and at least 10.6 g, 10.7, 10.8, 10.9, 11.0, 11.1, 11.2, 11.3, 11.4, 11.5, 11.6, 11.7, 11.8, 11.9, or at least 12.0 g of a wholegrain ingredient per 40 g of the baked product.

Between the confectionery component and the baked component there may be no more than 19.0.g, 18.5, 18.0, 17.5, 17.0, 16.5, 16.0, 15.5, 15.4, 15.3, 15.2, 15.1, 15.0, 14.9, 14.8, 14.7, 14.6, 14.5, 14.4, 14.3, 14.2, or no more than 14.1 g of an ingredient derived from nuts and/or seeds per 40 g of the baked product; and no more than 15.0 g, 14.5, 14.0, 13.5, 13.0, 12.5, 12.0, 11.9, 11.8, 11.7, 11.6, 11.5, 11.4, 11.3, 11.2, 11.1, 11.0, 10.9, 10.8, 10.7 or no more than 10.6 g of a wholegrain ingredient per 40 g of the baked product.

Between the confectionery component and the baked component there may be from 14.17-19.0 g, 14.17-18.5, 14.17-18.0, 14.17-17.5, 14.17-17.0, 14.17-16.5, 14.17-16.0, 14.17-15.5, 14.17-15.4, 14.27-15.3, 14.17-15.2, 14.17-15.1, 14.17-15.0 g of an ingredient derived from nuts and/or seeds per 40 g of the baked product; and from 10.6-15.5 g, 10.6-15.4, 10.6-15.3, 10.6-15.2, 10.6-15.1, 10.6-15.0, 10.6-14.9, 10.6-14.8, 10.6-14.7, 10.6-14.6, 10.6-14.5, 10.6-14.4, 10.6-14.3, 10.6-14.2, 10.6-14.1 or from 10.6-14.0 g of a wholegrain ingredient per 40 g of the baked product.

Between the confectionery component and the baked component there may be at least 14.17 g, 14.2, 14.3, 14.4, 15.5, 14.6, 14.7, 14.8, 14.9, 15.0, 15.1, 15.2, 15.3, 15.4, 15.5, 16.0, 16.5, 17.0, 18.5, 19.0, or at least 20.0 g of an ingredient derived from nuts and/or seeds per 50 g of the baked product; and at least 10.6 g, 10.7, 10.8, 10.9, 11.0, 11.1, 11.2, 11.3, 11.4, 11.5, 11.6, 11.7, 11.8, 11.9, 12.0, 12.5, 13.0, 13.5, 14.0, 14.5, or at least 15.0 g of a wholegrain ingredient per 50 g of the baked product.

Between the confectionery component and the baked component there may be no more than 20.0 g, 19.5, 19.0, 18.5, 18.0, 17.5, 17.0, 16.5, 16.0, 15.5, 15.4, 15.3, 15.2, 15.1, 15.0, 14.9, 14.8, 14.7, 14.6, 14.5, 14.4, 14.3, 14.2, or no more than 14.1 g of an ingredient derived from nuts and/or seeds per 50 g of the baked product; and no more than 20.0 g, 19.5, 19.0, 18.5, 18.0, 17.5, 17.0, 16.5, 16.0, 15.5, 15.0, 14.5, 14.0, 13.5, 13.0, 12.5, 12.0, 11.9, 11.8, 11.7, 11.6, 11.5, 11.4, 11.3, 11.2, 11.1, 11.0, 10.9, 10.8, 10.7 or no more than 10.6 g of a wholegrain ingredient per 50 g of the baked product.

Between the confectionery component and the baked component there may be from 14.17-19.0 g, 14.17-18.5, 14.17-18.0, 14.17-17.5, 14.17-17.0, 14.17-16.5, 14.17-16.0, 14.17-15.5, 14.17-15.4, 14.27-15.3, 14.17-15.2, 14.17-15.1, 14.17-15.0 g of an ingredient derived from nuts and/or seeds per 50 g of the baked product; and from 10.6-20.0 g, 10.6-19.5, 10.6-19.0, 10.6-18.5, 10.6-18.0, 10.6-17.5, 10.6-17.0, 10.6-16.5, 10.6-16.0, 10.6-15.5, 10.6-15.4, 10.6-15.3, 10.6-15.2, 10.6-15.1, 10.6-15.0, 10.6-14.9, 10.6-14.8, 10.6-14.7, 10.6-14.6, 10.6-14.5, 10.6-14.4, 10.6-14.3, 10.6-14.2, 10.6-14.1 or at least 10.6-14.0 g of a wholegrain ingredient per 50 g of the baked product.

The baked product may comprise one or more further ingredients.

The further ingredient may be one or more ingredients selected from the group comprising a sugar, fat, oil, emulsifier, thickener, preservative, water, colors, flavors, sweetener and sugar replacer.

The sugar, fat, oil, emulsifier, thickener, preservative, water, colors, flavors, sweetener, and/or sugar replacer may be as described in the first aspect of the invention.

The sugar, fat, oil, emulsifier, thickener, preservative, water, colors, flavors, sweetener, and/or sugar replacer may be present in the same amounts as described in the first aspect of the invention.

The baked product may comprise less than 25, 24.9, 24.8, 24.7, 24.6, 24.5, 24.4, 24.3, 24.2, 24.1, 24, 23.9, 23.8, 23.7, 23.6, 23.5, 23.4, 23.3, 23.2, 23.1, 23, 22.9, 22.8, 22.7, 22.6, 22.5, 22.4, 22.3, 22.2, 22.1, 22, 21.9, 21.8, 21.7, 21.6, 21.5, 21.4, 21.3, 21.2, 21.1, 21, 20.9, 20.8, 20.7, 20.6, 20.5, 20.4, 20.3, 20.2, 20.1, 20, 19.9, 19.8, 19.7, 19.6, 19.5, 19.4, 19.3, 19.2, 19.1, 19, 18.9, 18.8, 18.7, 18.6, 18.5, 18.4, 18.3, 18.2, 18.1, 18, 17.9, 17.8, 17.7, 17.6, 17.5, 17.4, 17.3, 17.2, 17.1, 17, 16.9, 16.8, 16.7, 16.6, 16.5, 16.4, 16.3, 16.2, 16.1, 16, 15.9, 15.8, 15.7, 15.6, 15.5, 15.4, 15.3, 15.2, 15.1, 15, 14.9, 14.8, 14.7, 14.6, 14.5, 14.4, 14.3, 14.2, 14.1, 14, 13.9, 13.8, 13.7, 13.6, 13.5, 13.4, 13.3, 13.2, 13.1, 13, 12.9, 12.8, 12.7, 12.6, 12.5, 12.4, 12.3, 12.2, 12.1, 12, 11.9, 11.8, 11.7, 11.6, 11.5, 11.4, 11.3, 11.2, 11.1, 11, 10.9, 10.8, 10.7, 10.6, 10.5, 10.4, 10.3, 10.2, 10.1, 10, 9.9, 9.8, 9.7, 9.6, 9.5, 9.4, 9.3, 9.2, 9.1, 9, 8.9, 8.8, 8.7, 8.6, 8.5, 8.4, 8.3, 8.2, 8.1, 8, 7.9, 7.8, 7.7, 7.6, 7.5, 7.4, 7.3, 7.2, 7.1, 7, 6.9, 6.8, 6.7, 6.6, 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or less than or equal to 0.1 wt % sugar, or 0 wt % sugar by weight of the baked product.

The baked product may comprise less than 25, 24.9, 24.8, 24.7, 24.6, 24.5, 24.4, 24.3, 24.2, 24.1, 24, 23.9, 23.8, 23.7, 23.6, 23.5, 23.4, 23.3, 23.2, 23.1, 23, 22.9, 22.8, 22.7, 22.6, 22.5, 22.4, 22.3, 22.2, 22.1, 22, 21.9, 21.8, 21.7, 21.6, 21.5, 21.4, 21.3, 21.2, 21.1, 21, 20.9, 20.8, 20.7, 20.6, 20.5, 20.4, 20.3, 20.2, 20.1, 20, 19.9, 19.8, 19.7, 19.6, 19.5, 19.4, 19.3, 19.2, 19.1, 19, 18.9, 18.8, 18.7, 18.6, 18.5, 18.4, 18.3, 18.2, 18.1, 18, 17.9, 17.8, 17.7, 17.6, 17.5, 17.4, 17.3, 17.2, 17.1, 17, 16.9, 16.8, 16.7, 16.6, 16.5, 16.4, 16.3, 16.2, 16.1, 16, 15.9, 15.8, 15.7, 15.6, 15.5, 15.4, 15.3, 15.2, 15.1, 15, 14.9, 14.8, 14.7, 14.6, 14.5, 14.4, 14.3, 14.2, 14.1, 14, 13.9, 13.8, 13.7, 13.6, 13.5, 13.4, 13.3, 13.2, 13.1, 13, 12.9, 12.8, 12.7, 12.6, 12.5, 12.4, 12.3, 12.2, 12.1, 12, 11.9, 11.8, 11.7, 11.6, 11.5, 11.4, 11.3, 11.2, 11.1, 11, 10.9, 10.8, 10.7, 10.6, 10.5, 10.4, 10.3, 10.2, 10.1, 10, 9.9, 9.8, 9.7, 9.6, 9.5, 9.4, 9.3, 9.2, 9.1, 9, 8.9, 8.8, 8.7, 8.6, 8.5, 8.4, 8.3, 8.2, 8.1, 8, 7.9, 7.8, 7.7, 7.6, 7.5, 7.4, 7.3, 7.2, 7.1, 7, 6.9, 6.8, 6.7, 6.6, 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or less than or equal to 0.1 wt % added sugar, or 0 wt % added sugar by weight of the baked product.

The term “added sugar” is used herein to refer to an additional amount of sugar that may be naturally present in one of the ingredients, and is added to the baked product during or after processing.

The baked product may comprise less than 25, 24.9, 24.8, 24.7, 24.6, 24.5, 24.4, 24.3, 24.2, 24.1, 24, 23.9, 23.8, 23.7, 23.6, 23.5, 23.4, 23.3, 23.2, 23.1, 23, 22.9, 22.8, 22.7, 22.6, 22.5, 22.4, 22.3, 22.2, 22.1, 22, 21.9, 21.8, 21.7, 21.6, 21.5, 21.4, 21.3, 21.2, 21.1, 21, 20.9, 20.8, 20.7, 20.6, 20.5, 20.4, 20.3, 20.2, 20.1, 20, 19.9, 19.8, 19.7, 19.6, 19.5, 19.4, 19.3, 19.2, 19.1, 19, 18.9, 18.8, 18.7, 18.6, 18.5, 18.4, 18.3, 18.2, 18.1, 18, 17.9, 17.8, 17.7, 17.6, 17.5, 17.4, 17.3, 17.2, 17.1, 17, 16.9, 16.8, 16.7, 16.6, 16.5, 16.4, 16.3, 16.2, 16.1, 16, 15.9, 15.8, 15.7, 15.6, 15.5, 15.4, 15.3, 15.2, 15.1, 15, 14.9, 14.8, 14.7, 14.6, 14.5, 14.4, 14.3, 14.2, 14.1, 14, 13.9, 13.8, 13.7, 13.6, 13.5, 13.4, 13.3, 13.2, 13.1, 13, 12.9, 12.8, 12.7, 12.6, 12.5, 12.4, 12.3, 12.2, 12.1, 12, 11.9, 11.8, 11.7, 11.6, 11.5, 11.4, 11.3, 11.2, 11.1, 11, 10.9, 10.8, 10.7, 10.6, 10.5, 10.4, 10.3, 10.2, 10.1, 10, 9.9, 9.8, 9.7, 9.6, 9.5, 9.4, 9.3, 9.2, 9.1, 9, 8.9, 8.8, 8.7, 8.6, 8.5, 8.4, 8.3, 8.2, 8.1, 8, 7.9, 7.8, 7.7, 7.6, 7.5, 7.4, 7.3, 7.2, 7.1, 7, 6.9, 6.8, 6.7, 6.6, 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or less than or equal to 0.1 wt % saturated fat, or 0 wt % saturated fat by weight of the baked product.

The baked product may be temperature-resistant or heat resistant.

In such an embodiment, the baked product may comprise one or more hydrated salts, hydrated sugars and hydrated sugar alcohols.

Hydrated salts may be selected from the group comprising hydrates of alkali metal salts and hydrates of alkaline earth metal salts, such as sodium carbonate decahydrate and magnesium carbonate pentahydrate.

Hydrated sugars may be selected from the group comprising hydrated monosaccharides, hydrated disaccharides and hydrated polysaccharides. Monosaccharides include, for example, dextrose (glucose), fructose (levulose), galactose, xylose and ribose, disaccharides include, for example, saccharose (sucrose) and lactose, and polysaccharides include, for example, starch, glycogen and cellulose. An exemplary and referred hydrated monosaccharide is dextrose monohydrate, and an exemplary and preferred hydrated disaccharide is lactose monohydrate.

The water content of the baked product may be greater than 1.1 wt. % by weight of the baked product. In some embodiments, the total water content may be greater than 1.15 wt. %, 1.2 wt. %, 1.25 wt. %, 1.3 wt. %, 1.35 wt. % or greater than 1.4 wt. % by weight of the baked product. In some embodiments, the water content may be less than 2.5 wt. %, 2.4 wt. %, 2.3 wt. %, 2.2 wt. %, 2.1 wt. % or less than 2.0 wt. % by weight of the baked product. When the water content is as defined above, the composition results in a baked product with improved heat-resistance and also good taste and mouthfeel.

The baked product may comprise a polyol gel product.

The polyol gel may be formed by gelation of a polyol or a polyol/water mixture with a gelling agent. The gelling agents may be selected from the group comprising gelatin, agarose, pectin, xanthan gum, agar, kappa-carrageenan, sodium alginate and iota-carrageenan.

The polyol which is used for gelation is preferably a liquid and may be a straight or branched chain hydrocarbon based compound containing at least two hydroxyl groups on the carbon skeleton. For example, the polyol may be a dihydric alcohol, a trihydric alcohol such as glycerol, mannitol, sorbitol, propylene glycol or corn syrup or any combination thereof.

The addition of a polyol gel to the baked product may improve the heat resistance of the product.

In some embodiments, the baked product may have reduced rancidity and/or be more resistant to oxidation.

In such an embodiment, the baked product may comprise one or more ingredients selected from the group comprising an antioxidant and a preservative.

Suitable antioxidants and/or preservatives may be selected from the group consisting of benzoic acid alkali metal salts (e.g., sodium benzoate), sorbic acid alkali metal salts (e.g., potassium sorbate), ascorbic acid (Vitamin C), citric acid, calcium propionate, sodium erythorbate, sodium nitrite, calcium sorbate, butylated hydroxyanisole (BHA), butylated hydroxytoluene (BHT), ethylenediaminetetraacetic acid (EDTA), tocopherols (Vitamin E), straight chain polyphosphates, or a combination thereof.

In some embodiments, the baked product may comprise a vitamin E compound.

The vitamin E compound may be selected from the group comprising a tocopherol, a tocotrienol, or a combination thereof.

In some embodiments, the vitamin E compound is a tocopherol. Tocopherols are naturally found in vegetable oils, nuts, seeds, and whole grains. Naturally produced forms of the tocopherol as well as synthetic forms can be used. The tocopherols occur in alpha, beta, gamma and delta forms.

In some embodiments, the tocopherol is selected from the group consisting of alpha-tocopherol, beta-tocopherol, gamma-tocopherol, delta-tocopherol, and combinations comprising at least one of the foregoing tocopherols.

In other embodiments, vitamin E compounds such as tocotrienols can also be used to modify, mask or reduce the unpleasant taste impression of a bitter-tasting substance when administered in the presence of at least one fat. Tocotrienols are naturally found in very low levels in select vegetable oils, palm fruit oil, wheat germ, barley, saw palmetto, and certain types of nuts and grains. Naturally produced forms of the tocotrienol as well as synthetic forms can be used.

Tocotrienols, like tocopherols, are members of the vitamin E family and are structurally similar to tocopherol. The tocotrienols, like the tocopherols, occur in alpha, beta, gamma and delta forms. The tocotrienols also have the same methyl structure at the ring, but differ from tocopherols by the presence of three double bonds in the hydrophobic side chain.

The baked product may be resistant to fat bloom and/or sugar bloom.

In such an embodiment, the baked product may comprise a sorbitan monoester.

The term “sorbitan monoester”, as used herein, refers to a sorbitan monoester selected from the group consisting of sorbitan monomyristate, sorbitan monopalmitate, sorbitan monostearate, sorbitan monoarachidate, and combinations thereof.

The sorbitan monoesters described herein are known to have some fat and/or sugar bloom retarding function when included in baked products.

Examples of other additives which may retard fat and/or sugar bloom in baked products may be selected from the group consisting of hydrogenated butter fat, butylated hydroxy anisole (BHA), glycerol, anhydrous glucose, amino acids such as alpha amino N-butyric acid, glycine, cysteine and glutamic acids, bile acids, cetyl alcohol, cholesterol, choline-HCL, citric acid monoglyceride, lactose, low HLB sucrose polyesters, maltrins, methionine, polymerized cocoa butter, phytic acid, polyglycerol fatty esters, propylene glycol fatty acid esters, and combinations thereof.

According to a third aspect of the invention, there is provided a method for preparing a baked product according to the first aspect of the invention, the method comprising the steps of providing a baked component and providing a confectionery component and depositing the confectionery component into or onto the baked product.

The method may comprise depositing one or more confectionery components into the baked product. The method may comprise depositing a plurality of confectionery components into the baked product.

In one embodiment, the confectionery component may be deposited onto a layer of the baked component. In such an embodiment, the confectionery component may be deposited as a layer onto a layer of a baked component.

In a further embodiment, the method may comprise the steps of providing a first baked component, a second baked component, and a confectionery component; depositing the confectionery component onto the first baked component; and depositing the second baked component onto the confectionery component.

Alternatively, the method may comprise the step of providing a baked component and a confectionery component, and coating the baked component with the confectionery component.

Any suitable method of coating known to those skilled in the art may be employed. Such a method may provide a layer of the confectionery component on a surface of the baked component. The method may comprise coating a layer of the confectionery component on at least 50% of the outer surface area of the baked component, or on at least 60, 70, 80, 90%, or on substantially 100% of the outer surface area of the confectionery component.

In some embodiments, the step of coating may comprise enrobing the baked component with a confectionery component. The method may comprise passing the baked component through a curtain or stream of the confectionery component. In one embodiment, the curtain or stream may be formed by a chocolate confectionery component falling from an elevated position relative to the baked component. The molten chocolate confectionery component may fall from an elevated trough or like device fed from a suitable container.

In some embodiments, the step of coating may comprise dipping the baked component into a confectionery component. Suitable methods of dipping include hand-dipping and dipping the baked component using suitable machinery known in the art.

In some embodiments, the step of coating may comprise pan coating the baked component with a confectionery component. Pan coating is known to those skilled in the art and makes use of rotating drums to coat a baked component with a confectionery component. The pan coating method may include but is not limited to one or more of: spray pan coating, ladling, and drip-feeding.

Alternatively, the method may comprise filling a baked component with a confectionery component. Any suitable method of filling known to those skilled in the art may be employed.

The process may comprise one or more steps to improve temperature or heat resistance.

In such an embodiment, the method may include a step of thermo-curing the confectionery component and/or baked component.

The process may comprise one or more steps to prevent fat and/or sugar bloom.

In such an embodiment, the method may comprise a step of tempering the baked product.

The method may comprise a step of tempering the confectionery component and/or the baked component.

According to a fourth aspect of the present invention there is provided a method for preparing a baked product of the second aspect of the present invention, the method comprising the step of combining at least one ingredient derived from nuts and/or seeds and at least one wholegrain ingredient.

The method may comprise a step of molding or extruding the baked product to form a bar or block, after combining the ingredients in The method may comprise a step of pressing the mixture of the at least one ingredient derived from nuts and/or seeds and at least one wholegrain ingredient, preferably cold-pressing (i.e., at ambient temperatures without heating the mixture or platens) sufficiently to compact the mixture into a consolidated mixture of substantially uniform thickness. The compression can be applied by spreading the mixture onto a level surface and applying compression from above. Any convenient suitable means can be used in this respect, such as by a mold, pressure platen or platens, a compression roller or rollers, or a conveyor belt. The compression treatment will increase the density of the mixture. For example, the compression may increase the density of the mixture by about 25 to 150 percent. In one exemplary non-limiting embodiment, the compression increases the density of the mixture from about 0.2 to about 0.4 g/cc before compression to about 0.45 to about 0.65 g/cc after compression.

The baked product can be formed in any suitable shape, size and thickness. It can have a regular or irregular geometric shape. Regular geometric shapes include, for example, rectangular, square, circular, or oval cross-sections. Although not limited thereto, the cereal bars may be cut into sizes having a weight of about 20 g to about 100 g. Preferably 30 to 50 g, more preferably 40 to 50 g, most preferably 40 g.

The process may comprise one or more steps to improve temperature or heat resistance.

In such an embodiment, the method may include a step of thermo-curing the baked product.

The process may comprise one or more steps to prevent fat and/or sugar bloom.

In such an embodiment, the method may comprise a step of tempering the baked product.

Statements of invention above relating to the baked product of the second aspect of the invention may also be applied to the fourth aspect of the invention.

According to a fifth aspect of the present invention, there is provided a packaged baked product according to the first or second aspect of the invention.

The baked product may be packaged in any suitable packaging material, which may in some embodiments be any one or more materials independently selected from the group comprising cardboard, paper, paperboard, flow-wrap plastics, metal foil, plastics foil and combinations and laminates thereof.

Suitable packaging for the baked product may be reclosable or not reclosable (or resealable or not resealable) as known to a person skilled in the art.

The further aspects of the present invention may incorporate any of the features of the other aspects of the invention described herein as desired or as appropriate.

### DETAILED DESCRIPTION OF THE INVENTION

In order that the invention may be more clearly understood one or more embodiments thereof will now be described, by way of example only.

### Inventive Baked Products

### Example 1

A baked product in the form of a sandwich cookie was produced containing the ingredients shown in Table 1 below. The baked product comprised a cream confectionery component and a biscuit baked component. The cream confectionery component was in the form of a layer sandwiched between two layers of a biscuit baked component.

The sandwich cookie had 10.16 g of ingredients derived from a dairy ingredient and 14.17 g of ingredients derived from nuts per 30 g of the baked product.

The resultant sandwich cookie had a sweet taste and indulgent mouthfeel, whilst providing a number of nutritious food groups in a recommended serving size.

TABLE 1
Ingredient nutritional profile for Example 1.

| | | Confectionery | Baked | Baked |
|---|---|---|---|---|
| | | component | component | product |
| Ingredient | Description | /15 g | /15 g | /30 g |
| Palm | Seed butter | 7.1 | | 7.1 |
| kernel oil | | | | |
| Palm | Seed powder | | 7.5 | 7.5 |
| kernel meal | | | | |
| Casein | Dairy protein | 0.1 | 1.65 | 1.75 |
| derived | | | | |
| from low | | | | |
| fat milk | | | | |
| Lactose | Dairy powder | 7.1 | | 7.1 |
| derived | | | | |
| from low | | | | |
| fat milk | | | | |
| Whey | Dairy powder | | 4 | 4 |
| derived | | | | |
| from low | | | | |
| fat milk | | | | |
| Oat flour | | | 1.75 | 1.75 |
| Baking | | | 0.1 | 0.1 |
| soda | | | | |
| Vanilla | | 0.1 | | 0.1 |
| Mono & | | 0.5 | | 0.5 |
| diglycerides | | | | |
| Sorbitan | | 0.1 | | 0.1 |
| tristearate | | | | |
| Total | | 15 | 15 | 30 |

### Example 2

A baked product in the form of a sandwich cookie was produced containing the ingredients shown in Table 2 below. The baked product comprised a cream confectionery component and a biscuit baked component. The cream confectionery component was in the form of a layer sandwiched between two layers of a biscuit baked component.

The sandwich cookie had 10.16 g of ingredients derived from a dairy ingredient and 14.17 g of ingredients derived from nuts per 30 g of the baked product.

The resultant sandwich cookie had a sweet taste and indulgent mouthfeel, whilst providing a number of nutritious food groups in a recommended serving size.

TABLE 2
Ingredient nutritional profile for Example 2.

| | | Confectionery | Baked | Baked |
|---|---|---|---|---|
| | | component | component | product |
| Ingredient | Description | /15 g | /15 g | /30 g |
| Cocoa | Seed butter | 7 | | 7 |
| butter | | | | |
| Cocoa | Seed powder | | 7 | 7 |
| powder | | | | |
| Casein | Dairy protein | | 5 | 5 |
| derived | | | | |
| from low | | | | |
| fat milk | | | | |
| Lactose | Dairy powder | 5 | | 5 |
| derived | | | | |
| from low | | | | |
| fat milk | | | | |
| Other | | q.s | q.s | 6 |
| ingredients | | | | |
| Total | | 30 | 30 | 30 |

### Example 3

A baked product in the form of a sandwich cookie was produced containing the ingredients shown in Table 3 below. The baked product comprised a cream confectionery component and a biscuit baked component. The cream confectionery component was in the form of a layer sandwiched between two layers of a biscuit baked component.

The sandwich cookie had 10.16 g of ingredients derived from a dairy ingredient and 14.17 g of ingredients derived from nuts and 10.6 g of a whole grain ingredient per 50 g of the baked product.

The resultant sandwich cookie had a sweet taste and indulgent mouthfeel, whilst providing a number of nutritious food groups in a recommended serving size.

TABLE 3
Ingredient nutritional profile for Example 3.

| | | Confectionery | Baked | Baked |
|---|---|---|---|---|
| | | component | component | product |
| Ingredient | Description | /25 g | /25 g | /50 g |
| Cocoa | Seed butter | 7 | | 7 |
| butter | | | | |
| Cocoa | Seed powder | | 7 | 7 |
| powder | | | | |
| Casein | Dairy protein | | 5 | 5 |
| derived | | | | |
| from low | | | | |
| fat milk | | | | |
| Lactose | Dairy powder | 5 | | 5 |
| derived | | | | |
| from low | | | | |
| fat milk | | | | |
| Wholegrain | | | 10 | 10 |
| ingredient | | | | |
| Other | | q.s | q.s | 16 |
| ingredients | | | | |
| Total | | 50 | 50 | 50 |

### Example 4

A baked product according to the second aspect of the present invention in the form of a breakfast bar was produced containing the ingredients shown in Table 4 below.

The baked product comprised a wholegrain ingredient in an amount of 10.6 g and an ingredient derived from nuts and/or seeds in an amount of 14.17 g per 40 g of the baked product.

The resultant sandwich cookie had a sweet taste and indulgent mouthfeel, whilst providing a number of nutritious food groups in a recommended serving size.

TABLE 4
Ingredient nutritional profile for Example 4.

| | | Baked |
|---|---|---|
| | | product |
| Ingredient | Description | /40 g |
| Cocoa mass | Seed butter | 14.2 |
| Wholegrain | Wholegrain | 10.8 |
| wheat flour | ingredient | |
| Refined | — | 5.0 |
| wheat flour | | |
| Maltitol | | 9.0 |
| Lecithin | | 0.3 |
| Baking | | 0.2 |
| soda | | |
| Chocolate | | 0.5 |
| liquor | | |
| Total | | 40.0 |

The one or more embodiments are described above by way of example only. Many variations are possible.

1. A baked product comprising at least one confectionery component and a baked component, wherein between the confectionery component and the baked component there is:
a) at least 10.6 g of a dairy derived ingredient per 30-50 g of the baked product; and
b) at least 14.17 g of an ingredient derived from nuts and/or seeds and/or at least 10.6 g of a wholegrain ingredient per 30-50 g of the baked product.

2. A baked product according to claim 1, wherein the dairy derived ingredient is at least one ingredient selected from the group comprising: one or more milk proteins; and one or more milk sugars derived from the group comprising whole milk, skimmed milk, low fat milk, skimmed milk powder, low fat milk powder, whole milk powder, anhydrous milk fat, and whey powder.

3. A baked product according to claim 2, wherein the dairy derived ingredient is a milk protein selected from the group comprising casein (for example selected from αs1-casein, αs2-casein, β-casein and κ-casein) and whey (for example selected from whey protein concentrate, whey protein isolate and whey protein hydrolysate); and the milk sugar is lactose.

4. A baked product according to claim 1, wherein the confectionery component comprises a dairy derived ingredient.

5. A baked product according to claim 1, wherein the confectionery component and/or the baked component comprises an ingredient derived from nuts and/or seeds.

6. A baked product according to claim 1, wherein the ingredient derived from nuts and/or seeds is at least one ingredient selected from the group comprising a nut butter, a seed butter, a nut paste, a seed paste, a nut oil, a seed oil, a nut fat, a seed fat, a nut meal and a seed meal.

7. A baked product according to claim 1, wherein the ingredient is derived from nuts and/or seeds selected from the group comprising almonds, peanuts, macadamia nuts, hazelnuts, coconut, pecans, palm, walnuts, pistachios, cashews, Brazil nuts, sunflower seeds, poppy seeds, pumpkin seeds, chia seeds, canola seeds coffee beans, cocoa beans, watermelon seeds, soy nuts, chestnuts, pine nut or any combination thereof.

8. A baked product according to claim 1, wherein the wholegrain ingredient is selected from the group comprising wheat, oat, barley, maize, brown rice, faro, spelt, emmer, rye, quinoa, amaranth, triticale and buckwheat.

9. A baked product according to claim 1, wherein the baked component and/or the confectionery component comprises the wholegrain ingredient.

10. A baked product according to claim 1, wherein the baked product comprises one or more further ingredients selected from the group comprising a sugar, fat, oil, emulsifier, thickener, preservative, water, colors, flavors, sweetener and sugar replacer.

11. A baked product comprising at least one baked component comprising an ingredient derived from nuts and/or seeds in an amount of at least 14.17 g per 30-50 g of the baked product and a wholegrain ingredient in an amount of at least 10.6 g per 30-50 g of the baked product.

12. A baked product according to claim 11, wherein the ingredient derived from nuts and/or seeds is at least one ingredient selected from the group comprising a nut butter, a seed butter, a nut paste, a seed paste, a nut oil, a seed oil, a nut fat, a seed fat, a nut meal and a seed meal.

13. A baked product according to claim 11, wherein the ingredient derived from nuts and/or seeds is derived from nuts and/or seeds selected from the group comprising almonds, peanuts, macadamia nuts, hazelnuts, coconut, pecans, palm, walnuts, pistachios, cashews, Brazil nuts, sunflower seeds, poppy seeds, pumpkin seeds, chia seeds, canola seeds coffee beans, cocoa beans, watermelon seeds, soy nuts, chestnuts, pine nut or any combination thereof.

14. A baked product according to claim 11, wherein the whole grain ingredient is selected from the group comprising wheat, oat, barley, maize, brown rice, faro, spelt, emmer, rye, quinoa, amaranth, triticale and buckwheat.

15. A baked product according to claim 11, wherein the baked product comprises one or more further ingredient selected from the group comprising a sugar, fat, oil, emulsifier, thickener, preservative, water, colors, flavors, sweetener and sugar replacer.

16. A method for preparing a baked product according to claim 1, the method comprising the steps of providing a baked component and providing a confectionery component and depositing the confectionery component into or onto the baked product.

17. A method for preparing a baked product according to claim 11, the method comprising the step of combining at least one ingredient derived from nuts and/or seeds and at least one wholegrain ingredient.

18. A packaged baked product according to claim 1.
